(19) United States
(12) Patent Application Publication
(10) Pub. No.: US 2023/0090336 A1
(43) Pub. Date: Mar. 23, 2023

(54) METHOD FOR PRODUCING A SHAPABLE CORE FOR MANUFACTURING COMPOSITE MATERIAL PRODUCTS, SHAPABLE CORE OBTAINED

(71) Applicant: Saertex France, Arandon-Passins (FR)

(72) Inventors: Yves Dumontet, Limas (FR); Thierry Klethi, Groslee-Saint-Benoit (FR)

(21) Appl. No.: 17/798,528

(22) PCT Filed: Feb. 8, 2021
(86) PCT No.: PCT/EP2021/052957

§ 371 Date: Aug. 9, 2022

(30) Foreign Application Priority Data
Feb. 10, 2020 (FR) FR2001306

(51) Int. Cl. A63F 9/10; C08L 75/04

(52) U.S. Cl. CPC A63F 9/10; C08L 75/04; A63F 2009/1027; C08L 2203/14

(57) ABSTRACT

The invention relates to a method for producing a shapable core (10) from a rigid panel (12), the plane of the panel being defined by the axes X and Y and the height H being oriented in the direction Z of an orthonormal reference frame, for producing composite material products, consisting in cutting the panel (12) to form core elements (16). According to the invention, the method consists in making the cuts (14, 34) along the axis Z, producing hooking means (17) on each of the core elements (16) cut in this way, so as to allow the core elements (16) to be connected to each other and to produce a hinge connection (22) with retention between the core elements (16) in the plane XY.

The invention relates to a method for producing a shapable core for producing composite material products. The invention also covers the shapable core obtained.

Today, and increasingly, a very large number of applications require the use of composite materials. Initially the reserve of the aeronautics, nautical and automotive fields, the use of composite materials is ever more frequent, and is found in almost all of industry, as well as the nautical, automotive and aeronautics industries.

The manufacturing techniques using composite materials have resulted in the emergence of very varied assemblies, which mainly associated a reinforcement element and a matrix. The reinforcement is mainly a fibrous element, such as a fabric made of mineral or organic fibers, for example glass or carbon fibers, or thermoplastic fibers. The matrix is mainly based on at least one epoxy or polyester resin for example. The reinforcement may be referred to as matte and, following application of the resin and polymerization, forms a composite material. In order to increase the resistance of the product made of composite materials, it is known to add a core which, positioned between at least two skins based on woven or non-woven fibers, allows for a significant improvement in the mechanical resistance, by increasing the inertia of the composite product thus obtained, following polymerization of the matrix. The thickness is significantly increased, but the amount of material and the weight of the product increase in a very moderate manner.

This manufacturing method, and the product thus obtained, often referred to as sandwich, can be implemented using fibers, resins or cores of very varied materials, providing very varied mechanical properties. For example, polyurethane foams, or polyethylene terephthalate foams, or any other synthetic foam, are often used as the core. More natural materials such as balsa or cork are also used, which have different technical characteristics but are often more expensive than the synthetic materials.

A method exists for producing a core which is particularly attractive from the perspective of the mechanical resistance, costs, and ease of implementation, and which was the subject of the French patent application FR 2 948 693, in the name of the same applicant as that of the present invention. Said method for producing a core comprising integrated bridging fibers for composite material panels consists in depositing a surplus of fibers on at least one of the two faces of the core, then needle punching some of said fibers in order to cause them to pass through the core, and then removing the fibers that have not been needle punched. Said bridging fibers, projecting from the faces, are intended to subsequently create a mechanical connection between the skins of the two faces of the core. The two faces of a core receive at least one skin, generally two skins, based on non-woven fibers of fabrics. The bridging fibers and the fibers of the skins/fabrics can be of different types and characteristics, which infinitely increases the combinations. In the case of forming pieces of composite material structures, the shapes to be obtained are rarely entirely planar. Before adding the resin and polymerizing, by whatever method, these panels must be able to be shaped so as to match given profiles, before polymerization and acquisition of mechanical resistance properties. Another aim is to be able to shape these panels without said panel breaking, because, before receiving the skins and the resin, the core remains fragile, especially in large dimensions. Yet another aim is to be able to obtain a finished piece having continuous surface state, without any projecting edge, without any step, without bumps, without waves, i.e. as perfect as possible, even before the final surface treatment, so as to limit the reworking, i.e. sanding, coatings, etc.

The method for producing a shapable core for panels in a general manner, according to the present invention, must allow for implementation of said method for producing a core with bridging fibers, and thus allow the shaping of panels comprising needle punching of fibers through the core material.

Whatever the material selected for the core, and irrespective of the resistance obtained after polymerization of the matrix of the sandwich, there are a number of restrictions for the implementation of the set of elements forming the composite material, before application and polymerization of the resin.

Indeed, in order to form large surfaces, for example a boat bridge, the type of materials of the rigid panel used for the core and specified above often offers only limited mechanical parameters prior to application and polymerization of the resin. This resistance limit relates more specifically to the limit of the compression resistance, more exactly the limit of the contact pressure resistance. Indeed, as long as the resin of the composite material is not applied and polymerized, the resistance of the shapable core to the contact pressure often remains relatively low.

Said limited resistance to the contact pressure poses problems during use and placement of the core and skins, especially on a non-planar shape. In practice, and in order to form large surfaces, it is necessary for the operator to move directly on said surfaces during assembly. During such movements, it is essential to be able to make use of a contact pressure resistance that is sufficiently high as to allow the operator to walk, but also to kneel or to rest on the surfaces during assembly, because the operator often has to rest on the surface of the composite material sandwich with his knees or his elbows. However, this punching pressure of resting on the elbows and/or knees has a higher impact, with the result that the movements and the work of the operators can thus damage the core and create dips in the surface of the material forming said core, which may be permanent. The foams have little mechanical resistance, but are also often not very resilient, and thus do not return to their initial shape after deformation. It could be conceivable, in order to increase the contact surface and reduce the contact pressure, to provide plates for the operators to rest, reducing the punching effect, distributing the weight over a larger surface, in the manner of snowshoes, but the practical and gestural aspects for the operators are of course worsened.

Consequently, these dips caused during the placement of the panels thus creates hollow deformations on the surface of said panels. Said deformations thus bring about deformation of the surface of the sandwich composite material, which remains after polymerization of the resin, and a surplus of resin is consumed if said volume of resin, linked to said deformation, is compensated in order to keep the same plane, which is naturally the case.

However, such surplus of resin, locally, is not satisfactory, since too great a thickness of resin, which is not reinforced, offers a limited resistance, which leads to an over-consumption of resin due to the natural filling of the dips, and thus an increase in costs; even the weight is penalized, without being able to gain any advantage from this. Generally, the shrinkages, depending on the thicknesses, are different, and visible deformations remain before finishing, and even rather after finishing, in particular after painting, which causes said faults to reappear.

In order to prevent the dips on the core during manufacture, a simple solution is to increase the density of the material forming the core, in order to thus increase the compression resistance of said core. However, the increase in the density leads to an increase in the rigidity, and thus a reduction in the shaping ability.

In the case of the formation of curved and/or rounded, indeed warped, surfaces, it is necessary to be able to fold, or more precisely to be able to curve, the panels. After a certain angle of curvature, in order to prevent rupture, one solution consists in cutting the core into units of smaller dimensions, so as to allow a shaping ability, and thus a gap between the units of material thus cut. A cutting technique is known consisting in cutting cubes of the same dimensions, in the core. The core cut in the form of cubes of the same dimensions is thus able to be curved and to fit to a curved surface. The major disadvantage is associated with the fact that such cutting into cubes cannot be kept in shape before use, because the cubes are dissociated. It is thus difficult to form large surfaces with ease.

One solution consists in adhesively bonding a flexible sheet, for example stitched, over the entirety of the upper or lower face of all the cubes, in order to interconnect them and preserve an integral entity which can be handled and easily transported. However, said stitched element requires the provision of additional material which, moreover, has to be adhesively bonded, and it is necessary to select from the materials which are compatible with the resin of the matrix.

It is also sometimes essential to connect said cut core elements when the method for manufacturing the composite material uses needle punching intended to cause bridging fibers, positioned on one face of a core, to pass to the opposite face of said core. Indeed, during the needle punching phase, it is essential to retain the material forming the core as though it were integral, in order that it can be needle punched without the risk of the needle moving or carrying away a piece of material forming the core, in the case mentioned above of cutting into cubes. Very often, the core has to be retained mechanically between two plates.

A known solution, for obtaining a shapable core, consists in forming partial cuts in the form of notches in the direction of the height of the core, but over a height that is smaller than the total height of said core.

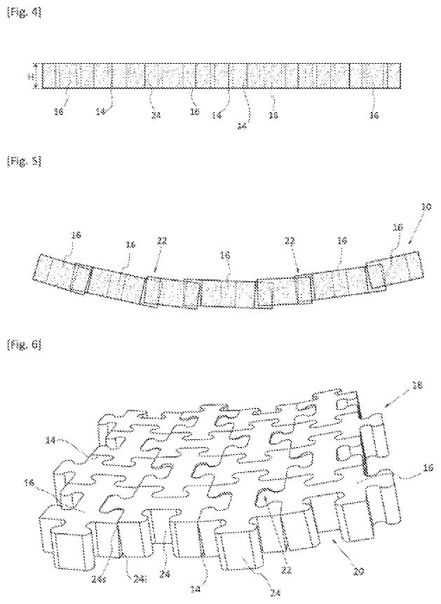

The American patent application US 2011081514 proposes numerous solutions for shaping cores cut into cubes. Variants provide for machining of the panels according to the curvature, in particular FIGS. 5 and 6, but this is worthwhile only when the parts are of a given, uniform curvature, which is absolutely not the case when forming a boat bridge or a boat cockpit, for example.

These notches thus increase the flexibility and the possibilities of curvature of the core. Nonetheless, the use of this method all the same makes shaping difficult, or indeed impossible, when the density of the core is significant, it being possible for any pronounced curvature to lead to ruptures adjacent to the notches. Indeed, in order to prevent dips during movements of workers on the core element, the density of the core must be sufficiently high, but the corollary is an increase in the rigidity. However, on account of the increased stiffness, the stresses are concentrated in particular in the thinner regions, which can thus cause breakages in the event of bending stresses that are too great, risking complete breakage of the core during shaping, and making the straight notches even more easily susceptible to rupture.

A product marketed under the designation ROHACELL® is also known, which can be cut and machined easily, but these are merely panels, without any reinforcement, and thus unsuitable for producing composite parts having high mechanical resistance, no through bridging fiber thus being provided. Said panels can be machined in order to be connected for example by a mortise and tenon joint, but such panels are unsuitable for the of composite material parts application according to the present invention.

Another problem is also that of limiting the mechanical resistance rupture regions, and the in-line cuts, such as those of the cubes, mentioned above, which causes lines of mechanical weakening. This is all the more noticeable when the cuts are straight and the panels do not have bridging fibers.

A problem to be overcome is that of the shaping ability. When a core has to be positioned on a given shape, for example a mold of a part of a boat, bridge, roof, it is noted that the shapable cores of the prior art, formed by cutting into cubes, exhibit some degree of resilience and still tend to return to a planar shape. This resilient effect disrupts the close-fitting shaping.

The present invention aims to overcome these problems by proposing panels which are highly mechanically resistant, solving the problems of punching, ensuring shaping ability, while remaining manipulable and offering all the combinations of materials for cores/skins/bridging fibers. The present invention proposes a method for manufacturing a shapable core for manufacturing a composite material product which offers possibilities for shaping on curved surfaces.

For this purpose, the method for producing a shapable core from a rigid panel, the plane of the panel being defined by the axes X and Y and the height H being oriented in the direction Z of an orthonormal reference frame, for producing composite material products, consists in cutting said panel to form core elements, the cuts being made along the axis Z, producing hooking means on each of the core elements cut in this way, so as to allow said core elements to be connected to each other and to produce a hinge connection with retention between said core elements in the plane XY. Each core element comprises hooking means in the form of protrusions and recesses, having mating profiles. Said hooking means are in the form of two protrusions and two recesses, having mating profiles and positioned on two opposing sides of each core element. In particular, the protrusions and the recesses are formed having the combined shape of a racket or mushroom, comprising a head and a thin connection.

The method consists, according to a variant, in making cuts in part according to the Z axis, at a height h that is less than the height H of the panel, creating a support base between the core elements. The different cuts are made using an oscillating blade, by milling, by laser, or using a punch.

According to another feature, bridging fibers FP are introduced into said shapable core, after the cutting of the core elements.

According to yet another feature, the method includes a step of surface treatment of applying a repositionable adhesive on at least one face of said shapable core.

The invention also covers the shapable core obtained by the implementation of the method.

The shapable core comprises bridging fibers FP which are oriented perpendicularly to the plane XY and/or are inclined. Said core is formed of a foam, in particular selected from the polyurethane foams. Said core advantageously comprises, on at least one face, repositionable adhesive.

The present invention will now be described according to a main embodiment and the variants thereof, with reference to the accompanying drawings, in which the various figures show:

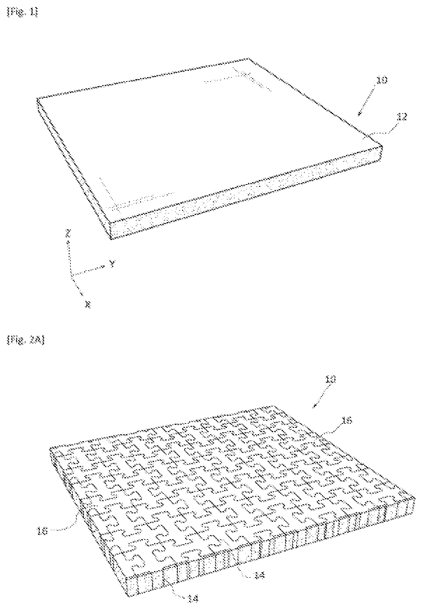

FIG. 1 is a perspective view of a rigid panel intended for the implementation of the method according to the present invention for producing a shapable core with the aim of manufacturing a composite material product.

FIG. 2A is a perspective view of a shapable core produced from the panel of FIG. 1, after implementation of the method according to the present invention.

FIG. 2B is a perspective view of a shapable core of FIG. 2A, after introduction of bridging fibers.

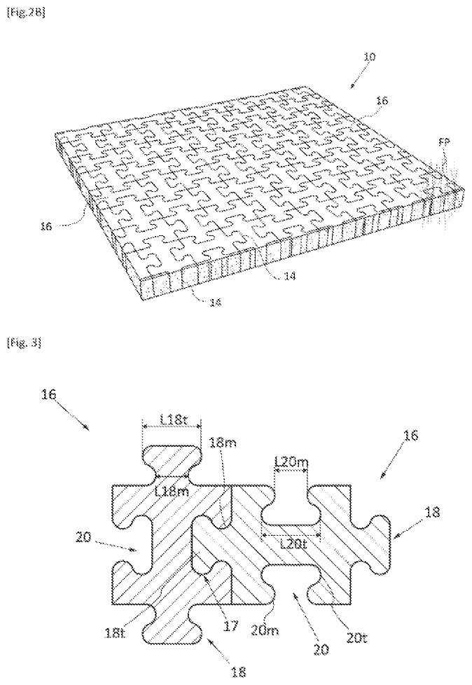

FIG. 3 is a schematic elevation view of two fitted core elements, said elements being identical for the shapable cores without or including bridging fibers.

FIG. 4 is a schematic cross-section of core elements of FIG. 3, obtained by the method according to the present invention from the rigid panel.

FIG. 5 is a schematic cross-section perpendicular to the plane of the panel, of core elements of FIG. 4, shaped according to a direction of curvature.

FIG. 6 is a perspective view of core elements of FIG. 4, shaped according to a direction of curvature.

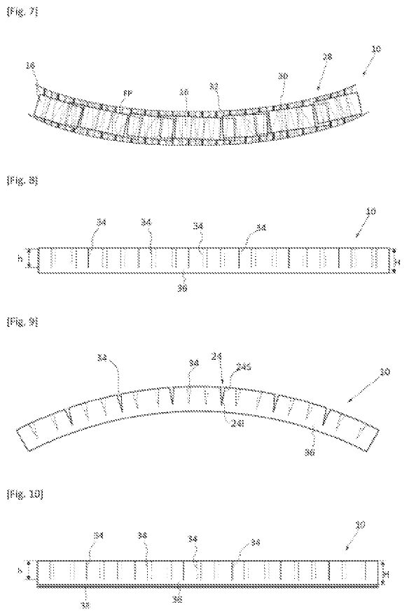

FIG. 7 is a cross-section of a product, shaped, made of composite materials, formed of a curved core formed of core elements, obtained according to the method of the present invention comprising bridging fibers and two skins, the assembly being embedded in a resin.

FIG. 8 is a schematic cross-section, according to the plane X/Z or YZ, of core elements, without or including bridging fibers, obtained by implementation of the method according to the present invention, provided with cuts of partial thickness.

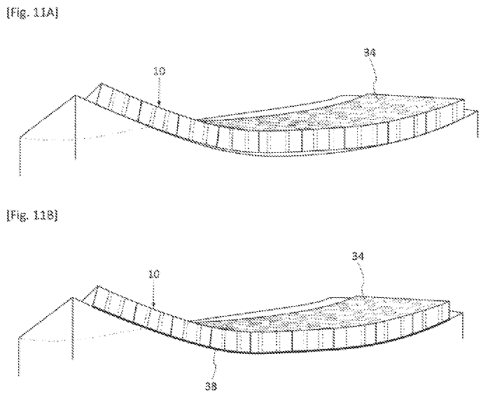

FIG. 9 is a cross-section of core elements of FIG. 8, shaped according to a direction of curvature, which is concave on the face which is not notched.

FIG. 10 is a cross-section of core elements obtained by the method according to the present invention, without or including bridging fibers, having undergone a surface treatment.

FIG. 11A is a cross-section of core elements obtained by the method according to the present invention, provided with cuts of partial thickness, without or including bridging fibers, obtained by implementation of the method according to the present invention, shaped on a warped former.

FIG. 11B is a cross-section of core elements as shown in FIG. 11A, shaped on a warped former, having undergone a surface treatment.

FIG. 1 shows, with the aim of producing a shapable core 10, a rigid panel 12, which is integral, in this case a rigid panel made of polyurethane foam, by way of example, without this being limiting.

FIG. 2A shows the rigid panel 12 after it has undergone regular cuts 14 of said rigid panel 12, according to the method of the present invention, over the entirety of the planar surface thereof, in the orthonormal plane X, Y, Z, in order to produce the shapable core 10. The plane of the core is defined by the axes XY, and the height is oriented according to the axis Z. The cuts 14 are made precisely, and create identical core elements 16, which can be seen more clearly in FIGS. 2 and 3. The width of the cuts 14, viewed in the plane XY, corresponds to the width of the cutting tool and to the amount of material removed in order to create the core elements 16, visible in FIG. 3. The cutting and the material removal by the tool creates a shaping space, which is not visible in FIG. 2A on account of the scale, but is represented by the thick cutting line. Said shaping space can be adjusted depending on the degree of shaping sought, by changing the thickness of the cut.

In FIG. 2B, the method is implemented in the same way, but said core undergoes, following cutting, introduction of bridging fibers FP, in particular introduced according to the teaching of the French patent FR 2 948 693 in the name of the same applicant as that of the present application. Said bridging fibers FP pass through the shapable core 10 at the height thereof and project, at least in part, on at least one face of said core. The bridging fibers FP may be perpendicular to the plane XY but also, advantageously, inclined. Said fibers pass through the core elements, ensuring the interconnection of said core elements, in all directions.

According to a particularly advantageous arrangement of the invention, the core elements 16, forming the shapable core 10, are of an identical shape which is inscribed in a parallelepiped, and are positioned in the same plane XY. Said core elements 16 are provided with hooking means 17 for hooking with one another, formed of protrusions 18, in this case two protrusions 18, and recesses 20, in this case two recesses 20, having mating profiles for the protrusions 18 and developed in the plane XY. The two protrusions 18 and the two recesses 20 of each core element 16 are positioned, respectively, on two opposing sides of the core element 16, the recesses 20 being mating profiles, in geometric terms, capable of receiving the protrusions 18.

In the embodiment that is shown and retained, the protrusions 18 and the recesses 20 are formed having the combined shape of a racket or mushroom, comprising a head 18t, 20t and a thin connection 18m, 20m. Respectively, and as visible in the elevation view of two core elements 16 of FIG. 3, the protrusions 18 have a convex head 18t, which projects, and a thin connection 18m, and the recesses 20 have a depression in the form of a concave, hollow head 20t, and a thin connection 20m. Said heads 18t of the protrusions 18 are of a width L18t, and said thin connections 18m of the protrusions 18 are of a width L18m. Analogously, said heads 20t of the recesses 20 are of a width L20t, and said thin connections 20m of the protrusions 20 are of a width L20m.

The geometry of the recesses 20 is virtually identical to that of the protrusions 18, to within a cut 14 thickness, i.e. to within the shaping space. Moreover, the width L18t is less than the width L20t, and the width of L18m is less than the width L20m, as specified in FIG. 3. The protrusions 18 are thus capable of being positioned in the recesses 20, thus creating a mechanical hinge 22 around the plane XY, with retention in this same plane XY, see FIGS. 5 and 6. The introduction or the disengagement are achieved only by translation in the direction Z, until complete disengagement.

The core elements 16 are also provided, on account of their geometry and their height H, with a vertical surface 24 which is deferred and is visible in FIGS. 4 and 6. Said vertical surfaces 24 of the core elements 16 are parallel when the shapable core 10 is placed flat and contained in the same plane XY.

FIGS. 5 and 6 are, respectively, a cross-section and a perspective view of a shapable core 10 which has been shaped, thus forming a curved element. It will be noted that, in this embodiment, the cuts 14 are made over the entire height, according to the axis Z. The core elements 16 remain assembled to one another via protrusions 18 and recesses 20. As can be seen in FIGS. 5 and 6, the vertical surfaces 24 of the core elements 16 are thus no longer mutually parallel, thus creating a very slight gap in the region of the mechanical hinge 22, on the convex face, and a constriction on the concave face, the gap being exaggerated for clarity of the drawings. Indeed, as shown in FIG. 5, the upper parts 24s of the juxtaposed core elements 16 are in pressing contact, and reversed, and the lower parts 24i of said core elements 16 are spaced apart, allowing the shaping ability of the core 10. The very slight offset thus created in the region of the mechanical hinges 22 and visible on all the joins between the heads 18 and the recesses 20 of the core elements 16.

FIG. 7 shows a composite material product, obtained from a core 10 according to the present invention, comprising bridging fibers FP. The shapable core 10, which is shaped, is formed of a set of core elements 16 which are identical to the core shown in FIG. 5. In this embodiment showing the possibilities of the present invention, the shapable core 10 has received through bridging fibers FP. Said through bridging fibers FP were introduced after cutting the core 10 into core elements 16.

Said core 10 comprising bridging fibers FP is intended for receiving at least one composite skin 28, in this case two composite skins, placed above and below the core 10 and physically interconnected by said through bridging fibers FP. Said composite skins 28 may be formed in an entirely known manner, of a fabric of threads, or of a non-woven of fibers 30 and a resin 32. The bridging fibers FP are thus embedded in the resin 32, like the fibers or threads of the two composite skins 28, the resin also flowing along the bridging fibers FP, through the shapable core.

The bridging fibers FP contribute to interconnecting the core elements without preventing the shaping ability before the resin is put in place, because the through bridging fibers FP can slide through the material forming the shapable core 10 when the core elements are spaced apart, in particular on such small distances. Thus, as can be seen, the final product comprises a core, bridging fibers FP which connect the two skins in all directions providing the final product, comprising resin, with very high mechanical properties. The type and the characteristics of the fibers of the skins and the bridging fibers can be selected so as to be different or identical. There is a very great variety of combinations.

FIG. 8 shows another variant of the shapable core 10 according to the invention, said core having undergone cuts 34 which are different from the cuts 14. Indeed, the geometry in the plane XY is identical, but the cuts 34 are made in part according to the axis Z, at a height h that is less than the height H of the rigid panel 12 which has become the shapable core 10. The formation of the cuts 34 thus creates a support base 36 which connects all the core elements 16. In the event of stress upon curvature, and as shown in FIG. 9, which shows a curved core 10, the support base 36 curves and fits the shape, causing the gap between the upper parts 24s of the surfaces 24 of the core elements 16. The support base 36 offers the finished part an improved surface appearance, and it is also most often positioned on the visible side of the finished part. The slits are thus compressed in the concave regions, and open in the convex regions. A shapable core of this kind can also be shaped in the other direction of curvature. For the most pronounced curvatures, since the slits have a limited compaction ability, it is preferable to keep the support base 36 on the concave side of the curvature.

The production of the cut shapable core 10 according to the method of the present invention will now be described. The rigid panel 12 may be formed of a material different from a foam. Apart from the economic aspect, the material selected must have a certain capacity for resisting compression, in order to authorize movements of people without being deformed by contact by the operators. For a polyurethane foam, and in order to give an order of magnitude, this corresponds to a density of approximately 60 kg/m³ (i.e. approximately 0.5 to 0.6 MPa compression resistance).

The rigid panel 12 is shown rough, flat, as shown in FIG. 1A, and then after having undergone cuts 14, as shown in FIGS. 2A and 2B. According to a first embodiment, these cuts 14 are made in a vertical manner, as through-cuts, according to the axis Z, i.e. along the entire height H of the rigid panel 12, in order to obtain the shapable core 10. The cuts 14 can be made using any cutting device, inter alia by means of an oscillating blade, milling, laser, waterjet, the important consideration being to allow for a cut that is sufficiently clean and precise. Said cuts 14 can also be made by a punch having the shape of the desired cuts, and making it possible to form all the cuts 14 on the entire rigid panel 12 in one single action, and thus creating the core elements 16 very rapidly.

The patterns of the cuts 14 thus form core elements 16 that are identical in shape and geometry, and oriented differently in the plane XY. After the cuts 14 are formed, the protrusions 18 are directly positioned in the recesses 20 of mating shape, providing a mechanical connection of the core elements 16 in the plane XY.

Indeed, the mating shapes of the protrusions 18 and of the hollows 20 prevent any significant movement and thus any separation of the core elements 16 in the plane XY of the shapable core 10. In addition, since the cuts 14 are of a very small thickness, measured in the plane XY of the core, of the order of a few tens of mm, the core elements 16 can thus be separated only by performing a vertical translation according to the axis Z, of one core element 16 relative to another core element 16, which makes it possible to cause the protrusions 18 to translate vertically with respect to the hollows 20, or vice versa, in order to form an interlocking connection and a hinge with retention.

If, for practical reasons or reasons of implementation, it is necessary to exactly retain the core elements 16 relative to one another, flat or in a curved manner, in order to prevent the relative vertical offset of the core elements 16, a non-through cut 34 may be made. Said non-through cut 34 is formed at a height h, in part, which is smaller than the height H of the shapable core 10. The formation of non-through cuts 34 thus creates a support base 36 which is developed according to the plane XY and which retains all the core elements 16 together in the same plane. The support base 36 makes it possible to facilitate the implementation of the shapable core 10 and prevents any offset of the core elements 16 relative to one another, and the low height provides shaping ability. The support base has another advantage during the production of the shapable core 10—when the core elements 16 undergo the addition of bridging fibers FP by needle punching, after the cuts 14 have been made, it is necessary to retain the core elements 16 relative to one another. Indeed, the needle punching of fibers through the core 10 is performed using needles which, on account of their hooking power, can possibly carry along a core elements 16 upon retraction of the needle and after the bridging fibers FP have passed into the material forming the core elements 16. Of course, it is not desirable for the core elements 16 to be taken away or carried along by the needle, and it is thus necessary to retain the core elements 16 by means of clamping, and thus prevent any movement of said core elements 16 according to the axis Z. The support base 36 also contributes to easily preventing the movement of the core elements 16 according to the axis Z, and makes it possible to retention the core elements 16 in their initial position, during the needle punching of the bridging fibers FP.

In the same way, when each shapable core 10 is cut in order to follow the contours of a geometric shape, the pieces of the core elements, thus cut, at the periphery are retained by the mechanical hinges 22 and by the continuity of the support base 36.

The stresses and the movements of the shapable core 10 in the plane XY are absorbed by the mechanical hinges 22. On account of their geometry, the mechanical hinges 22, formed by the protrusions 18 and the hollows 20, are able to absorb the stresses in the plane XY. Indeed, the width L18t of each of the heads 18t of the protrusions 18 is wider than the width L20m of each of the thin parts of the hollows 20. Separation of the protrusions 18 and the hollows 20 according to the plane XY is thus impossible, which thus prevents any separation of the core elements 16 according to the plane XY, in all directions of said plane, and thus allows for absorption of stresses in the plane XY, while allowing a hinge effect having a limited angulation but sufficient for shaping ability.

Except for the core elements 16 positioned at the periphery of a shapable core 10, each core element 16 is fitted together with four other core elements 16-1, 16-2, 16-3 and 16-4 which surround it, visible in FIGS. 2A and 2B.

As is visible in these same figures, the mechanical hinges 22 created by the protrusions 18 and the recesses 20 also make it possible to retain the core elements 16, cut so as to form a transverse cut of the shaped core 10. The present invention thus allows any form of cut, without the risk of the core elements 16 separating from one another.

In the case of use of bridging fibers FP, the retention of the core elements 16 is also achieved by the bridging fibers FP themselves, which thus promote the handling and positioning of the shapable core 10 before composite skins or any other stratification element is applied.

According to a variant of the method according to the present invention, it is also possible for the shapable core according to the present invention to undergo a surface treatment. Said surface treatment consists in applying repositionable adhesive 38 to at least one of the faces of said shapable core 10. Said repositionable adhesive may be applied by spraying in the solvent phase, or hot if the adhesive is of the hot melt type, to cite just these examples. A detailed method of an implementation of this kind is found in the patent application FR 2.865.431, in the name of the same applicant. In this case, this method has an application from the perspective of the placement of the shapable core 10 according to the present invention, in a vertical mold for example, or on a slope, such as a boat hull or boat bridge mold. Said repositionable adhesive 18 has another significant advantage which has never been mentioned because the question had not arisen before the existence of the present invention.

This advantage is illustrated in FIGS. 11A and 11B. When a shapable core 10 is placed on a former having a warped surface, it is difficult to perfectly fit said shapable core 10 on said surface, on account of the curvature changes. Said shapable core 10 is indeed integral, even after cutting, on account of the hooking means 17, and bridging fibers FP when these are provided, but said core retains some spring effect. Since the imperfect fit is not satisfactory, it is found that the surface treatment using repositionable adhesive ensures perfect fitting, which is detachable in the event of error or the need for adjustment, until it is placed in resin and undergoes polymerization. Such fitting is show in FIG. 11B. A removable cleanliness sheet makes it possible to keep clean the surface which bears said repositionable adhesive 38, until installation, after removal of said sheet.

It will also be noted that the method according to the present invention makes it possible to produce cores of rigid material which are shapable, in order to form rolls, which is of some advantage with regard to handling during transport or on site, or indeed for the use of large surfaces.

1. A method for producing a shapable core (10) from a rigid panel (12), the plane of the panel being defined by the axes X and Y and the height H being oriented in the direction Z of an orthonormal reference frame, for producing composite material products, consisting in cutting said panel (12) to form core elements (16), characterized in that said method consists in making the cuts (14, 34) along the axis Z, producing hooking means (17) on each of the core elements (16) cut in this way, so as to allow said core elements (16) to be connected to each other and to produce a hinge connection (22) with retention between said core elements (16) in the plane XY.

2. The method for producing a shapable core (10) according to claim 1, characterized in that hooking means (17), in the form of protrusions (18) and two recesses (20), having mating profiles, are formed on each core element (16).

3. The method for producing a shapable core (10) according to claim 2, characterized in that hooking means (17), in the form of two protrusions (18) and two recesses (20), having mating profiles and positioned on two opposing sides of each core element (16), are formed on each core element (16).

4. The method for producing a shapable core (10) according to claim 2, characterized in that the protrusions (18) and the recesses (20) are formed having the combined shape of a racket or mushroom, comprising a head (18t, 20t) and a thin connection (18m, 20m).

5. The method for producing a shapable core (10) according to claim 1, characterized in that cuts (34) are made in part according to the Z axis, at a height h that is less than the height H of the panel (12), creating a support base (36) between the core elements (16).

6. The method for producing a shapable core (10) according to claim 1, characterized in that the cuts (14, 34) are made using an oscillating blade by milling, by laser, or using a punch.

7. The method for producing a shapable core (10) according to claim 1, characterized in that bridging fibers FP are introduced into said shapable core (10), after the cutting of the core elements (16).

8. The method for producing a shapable core (10) according to claim 1, characterized in that a surface treatment of applying a repositionable adhesive (38) on at least one face of said shapable core (10) is performed.

9. A shapable core (10) obtained by implementing the method according to claim 1, having a plane according to the axes X and Y and a height according to the axis Z, characterized in that it comprises core elements (16) provided with hooking means (17) for hooking said core elements (16) to one another.

10. The shapable core (10) according to claim 9, characterized in that it comprises hooking means (17) having protrusions (18) and recesses (20) having a mating profile, each protrusion (18) or recess (20) having a combined shape of a racket or mushroom, comprising a head (18t, 20t) and a thin connection (18m, 20m), so as to ensure retention in the plane XY.

11. The shapable core (10) according to claim 9, characterized in that it comprises cuts (34) which are made in part according to the Z axis, creating a support base (36) between the core elements (16).

12. The shapable core (10) according to claim 9, characterized in that it comprises bridging fibers FP which are oriented perpendicularly to the plane XY and/or are inclined.

13. The shapable core (10) according to any of claim 9, characterized in that it is formed of a foam.

14. The shapable core (10) according to claim 13, characterized in that the foam is selected from the polyurethane foams.

15. The shapable core (10) according to any of claim 9, characterized in that it comprises repositionable adhesive (38) on at least one face.
